(19) United States
(12) Patent Application Publication
(10) Pub. No.: US 2006/0026070 A1
(43) Pub. Date: Feb. 2, 2006

(54) Electronic coupon transaction system and method

(75) Inventor: Chung-Yo Sun, Jhudong Township (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/188,528

(22) Filed: Jul. 26, 2005

(30) Foreign Application Priority Data
Jul. 28, 2004 (TW) 093122553

(51) Int. Cl. G06Q 30/00

(52) U.S. Cl. 705/14

(57) ABSTRACT

The invention provides an electronic coupon transaction method and system. The electronic coupon transaction system comprises an interactive service server located in a shop, an electronic coupon delivery server, and a wireless communication device used by a buyer. The shop is provided with an ID and allowed to edit and send an electronic coupon to the electronic coupon delivery server. Thus, the buyer can use the wireless mobile device to download the electronic coupon. When purchasing at the shop, the buyer can browse electronic coupons based on the ID of the shop and select one or more of them to transact with the shop. As an electronic coupon requested by the buyer is run out, the electronic coupon delivery server reserves the requested electronic coupon, and sends a short message to the buyer when the requested electronic coupon is available.

### BACKGROUND OF THE INVENTION

1. Field of the Invention

The invention relates to a transaction system and method, and more particularly, to an electronic coupon transaction system and method

2. Description of Related Art

Most shops promote their goods by, such as advertising in various media and sending various coupons to consumers in order to successfully sell the goods. The coupons are sent to consumers via print media (e.g., newspapers, magazines, and the like), networks, and short messages of mobile phones. Such a way can increase trades, but cannot obtain a client's data to further use in, for example, the consumer habit analysis to thus provide more appropriate goods.

On the buyer side, it is inconvenient for the buyer to carry with various coupons. Besides, people do not cut out, print or collect the coupons constantly. In this case, the coupons are not obtained, stored and used easily by the buyer. At this point, since almost everyone has one mobile phone, integrating electronic coupons into the mobile phone to accordingly overcome the above problem is thus an important subject.

### SUMMARY OF THE INVENTION

The object of the invention is to provide an electronic coupon transaction system and method, which can provide a user to effectively use and manage electronic coupons, and provide a shop to effectively use buyer's information.

According to a feature of the invention, an electronic coupon transaction system is provided. The system includes an interactive service server located in a shop, an electronic coupon delivery server to provide electronic coupons edited by the shop, and a wireless communication device used by a buyer. The wireless communication device obtains the electronic coupons by connecting with the electronic coupon delivery server, and thus the buyer downloads one of the electronic coupons through the wireless communication device and accordingly transacts with the shop by connecting the wireless communication device with the interactive service server.

According to another feature of the invention, an electronic coupon transaction method is provided, which allows a buyer to use electronic coupons to transact with a shop. The shop implements with an interactive service server. The method includes an electronic coupon editing step, an electronic coupon receiving step, and a transacting step. The electronic coupon editing step is executed to provide the shop to edit electronic coupons and to store them in an electronic coupon delivery server. The electronic coupon receiving step is executed to provide the buyer to use a wireless communication device to receive stored electronic coupons from the electronic coupon delivery server. The transacting step is executed to provide the buyer to connect the wireless communication device with the interactive service server in order to select an electronic coupon for transaction with the shop.

Other objects, advantages, and novel features of the invention will become more apparent from the following detailed description when taken in conjunction with the accompanying drawings.

### BRIEF DESCRIPTION OF THE DRAWINGS

FIG. 1 is a configuration diagram of an electronic coupon transaction system according to an embodiment of the invention;

FIG. 2 is a configuration diagram of an electronic coupon delivery server according to an embodiment of the invention;

FIG. 3 is a configuration diagram of an interactive service server according to an embodiment of the invention; and

FIG. 4 is a flowchart of an electronic coupon transaction method according to an embodiment of the invention.

### DETAILED DESCRIPTION OF THE PREFERRED EMBODIMENT

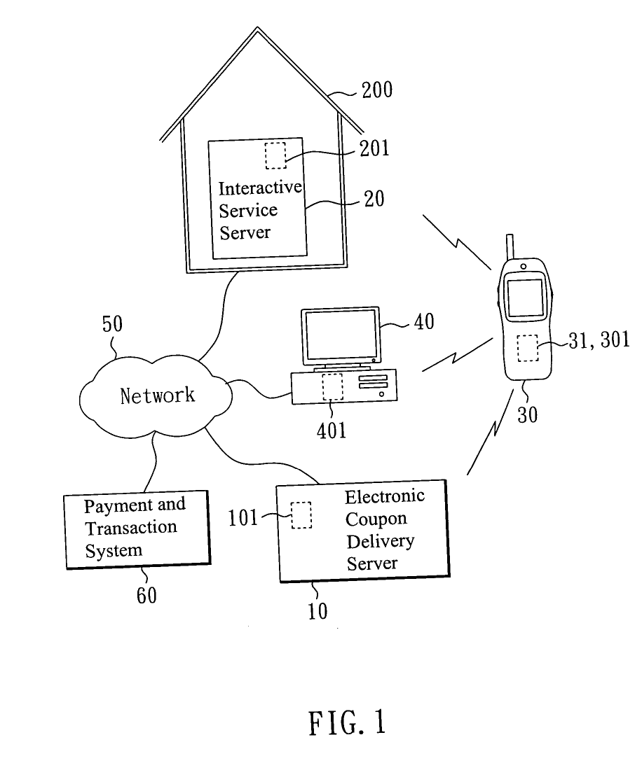

FIG. 1 is a configuration diagram of an electronic coupon transaction system according to an embodiment of the invention. In FIG. 1, the system includes one or more interactive service servers 20, an electronic coupon delivery server 10, a wireless communication device 30 used by a buyer and a client-end computer 40. The interactive service server 20 can be a proprietary server or a typical personal computer, which is located in a shop 200 such that the buyer can use electronic coupons to transact with the shop 200. The electronic coupon delivery server 10 is located in a public place, such as a subway, railroad or bus station, and convenience store, to thus provide the buyer to use the wireless communication device 30 to conveniently request an electronic coupon from the electronic coupon delivery server 10. The wireless communication device 30 can be a mobile phone.

As shown in FIG. 1, each shop 200 has an identification (ID). The buyer can obtain the ID for identifying the shop 200 when connecting the mobile phone 30 with the interactive service server 20 of the shop 200. The electronic coupon delivery server 10 has electronic coupons, which are edited by the shop 200 through the interactive service server 20 and loaded through the network 50. The mobile phone 30 has a wireless module 301 to communicate with the electronic coupon delivery server 10 or the interactive service server 20 in a wireless manner, to accordingly request an electronic coupon or undertake an electronic transaction. The wireless module 31 is preferably a bluetooth module 301. Similarly, the servers 10 and 20 also have the corresponding bluetooth modules 101 and 201.

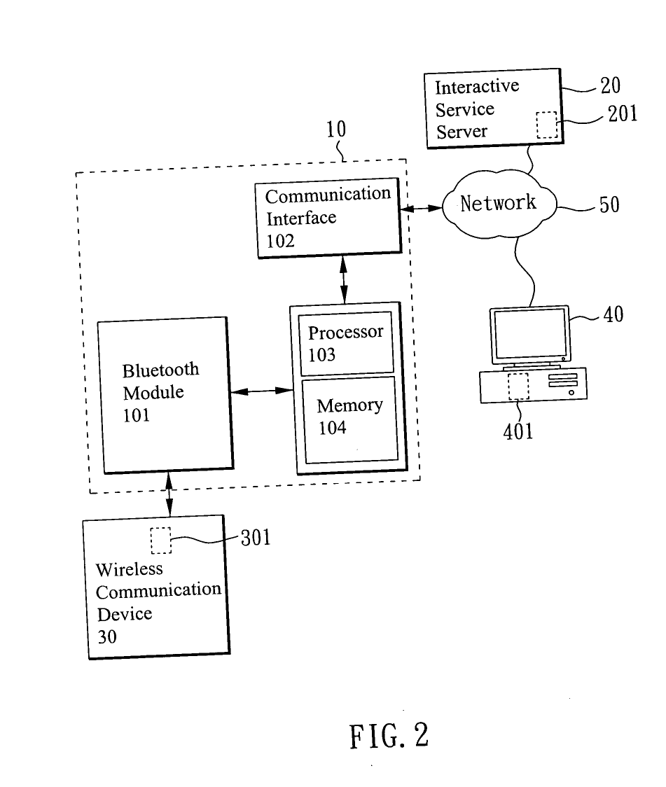

FIG. 2 is a configuration diagram of the electronic coupon delivery server 10 according to an embodiment of the invention. In FIG. 2, the electronic coupon delivery server 10 includes a processor 103, a memory 104, a communication interface 102 and a bluetooth module 101. As shown in FIG. 2, the processor 103 is able to store, update, change, delete and search for electronic coupons. The electronic coupon delivery server 10 receives electronic coupons edited completely by the shop 200 through the communication interface 102 and further stores them in the memory 104. The bluetooth module 301 of the mobile phone 30 used by the buyer can connect with the bluetooth module 101 of the delivery server 10. The processor 103 selects required electronic coupons from which the memory 104 stores. The required electronic coupons are sent to the mobile phone 30 through the bluetooth module 101. In addition, when the mobile phone 30 is used in the electronic coupon transaction system by the buyer at the first time, associated software can be downloaded from the delivery server 10 to the mobile phone 30 in order to provide the buyer to conveniently manage and use the downloaded electronic coupons. The software included in mobile phone 30 can also record valid dates for the downloaded electronic coupons. Accordingly, the mobile phone 30 can use a screen display or output a voice message to remind the buyer before a valid date is immediately reached.

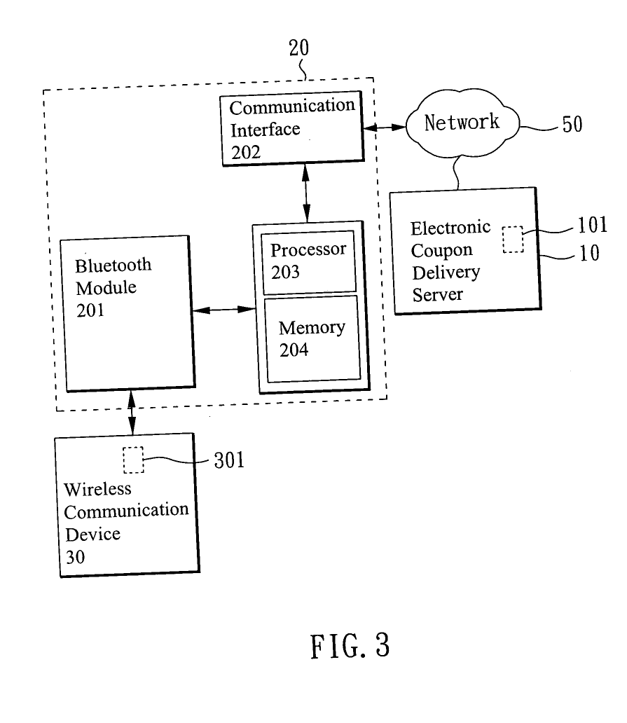

FIG. 3 is a configuration diagram of an interactive service server 20 according to an embodiment of the invention. In FIG. 3, the interactive service server 20 includes a processor 203, a memory 204, a communication interface 202 and a bluetooth module 201. As shown in FIG. 3, the processor 203 is able to store, edit, update, change, delete and search for electronic coupons. When electronic coupons are completely edited by the shop owner using the web browser of the interactive service server 20, the electronic coupons are stored in the electronic coupon delivery server 10 through the communication interface 202. Thus, the buyer can conveniently request the required electronic coupons and store them in the mobile phone 30. When the buyer purchases goods in the shop 200, the bluetooth module 301 of the mobile phone 30 used by the buyer can connect with the bluetooth module 201 of the interactive service server 20, and accordingly select appropriate electronic coupons for transactions.

In addition, for more conveniently requesting the required electronic coupons, referring again to FIG. 1, the mobile phone 30 of the buyer can connect to the delivery server 10 through the client-end computer 40. The client-end computer 40 can be a personal computer located in the buyer's home or a convenience store. The personal computer can connect to the delivery server 10 by networking, such as Internet, and to the mobile phone 30 through its internal bluetooth module 401. Thus, the mobile phone 30 can connect to the delivery server 10 through the client-end computer 40, thereby obtaining the required electronic coupons.

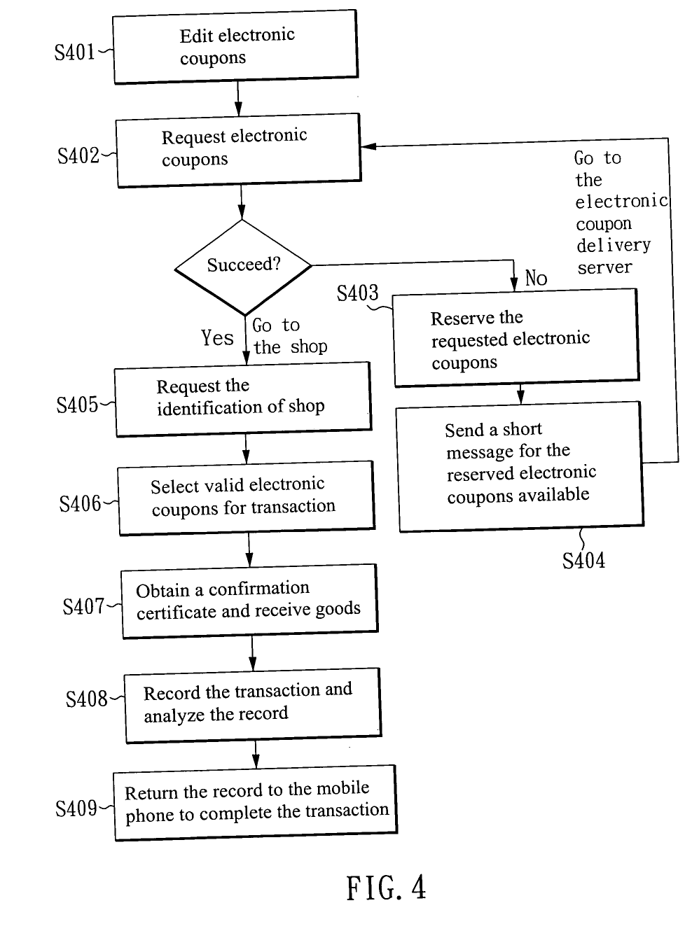

Accordingly, the present electronic coupon transaction system allows the buyer to conveniently request, manage and use the electronic coupons in transactions. FIG. 4 is a flowchart of an electronic coupon transaction method. As shown in FIG. 4, the shop 200 uses the interactive service server 20 to edit electronic coupons and store them in the electronic coupon delivery server 10 (step S401). The buyer can use the mobile phone 30 to request the required electronic coupons from the delivery server 10 (step S402). When the required electronic coupons are run out, the buyer can use the mobile phone 30 to request the delivery server 10 for reservation (step S403) such that the delivery server 10 sends a short message to the buyer when the required electronic coupons are available (step S404). In this case, the buyer uses the mobile phone 30 again to connect with the delivery server 10 to thus obtain the required electronic coupons (step S402).

When transacting with the shop 200, the buyer uses the mobile phone 30 to connect with the interactive service server 20 in order to obtain the ID of the shop 200, and accordingly finds and lists corresponding electronic coupons (step S405). The buyer then selects one or more of the electronic coupons through the mobile phone 30 connecting with the interactive service server 20 to transact with the shop 200 (step S406). Referring again to FIG. 1, the interactive service server 20 of the shop 200 can connect with a payment and transaction system 60 (e.g., credit card transaction system) to provide the buyer to undertake an electronic payment and transaction. After transaction, the shop 200 gives the buyer a conformation certificate to accordingly obtain purchased goods (step S407), thereby completing a substantial transaction.

In addition, the shop 200 can further record the buyer's transaction and basic information to accordingly analyze the consumer information (step S408) for providing more appropriate electronic coupons. The shop 200 sends the transaction information back to the mobile phone 30 of the buyer, thereby completing the entire transaction. At this point, the mobile phone stores the transaction information for use as a reference to analyze the consumer's transacting behavior (step S409) and automatically deletes the used electronic coupons.

In view of the forgoing, it is known that the electronic coupon transaction system and method can provide the buyer to conveniently request, manage and use electronic coupons in transaction, and allow the shop to effectively use the buyer's information. In summary, the following functions are obtained:

1. A consumer with a mobile phone does not require addition expenditure and can obtain coupons in a bluetooth communication manner. Also, the coupons can be managed and used with the mobile phone to accordingly increase coupon utilization ratio.

2. The system can be constructed easily, which is complete by implementing the electronic coupon delivery server only in subways, railway or bus stations, convenience stores and combining with the shops' interactive service servers and the buyers' mobile phones.

3. A shop can conveniently obtain a loyal client's basic information from transaction and further use it in, for example, data investigation analysis to understand consumer habits, thereby obtaining doubling effect and increasing marketing efficiency.

4. The buyer can acquire electronic coupons beforehand and store them in the mobile phone to be a shopping guide.

5. The utility of electronic coupons and the effective management and use of consumer information are increased.

Although the present invention has been explained in relation to its preferred embodiment, it is to be understood that many other possible modifications and variations can be made without departing from the spirit and scope of the invention as hereinafter claimed.

What is claimed is:

1. An electronic coupon transaction system, comprising:
an interactive service server, which is located in a shop;
an electronic coupon delivery server, which has electronic coupons provided and edited by the shop; and
a wireless communication device, which is used by a buyer to obtain the electronic coupons provided by the shop through a connection with the electronic coupon delivery server and to accordingly select one or more of the electronic coupons through a connection with the interactive service server for transaction.

2. The system as claimed in claim 1, wherein the shop corresponding to the interactive service server has an identification to accordingly find and list the electronic coupons provided by the shop when the buyer uses the wireless communication device to connect with the interactive service server.

3. The system as claimed in claim 1, wherein the wireless communication device is a mobile phone, and the mobile phone and the electronic coupon delivery server respectively have a bluetooth module to establish a wireless connection.

4. The system as claimed in claim 1, wherein the wireless communication device is a mobile phone, and the mobile phone and the interactive service server respectively have a bluetooth module to establish a wireless connection.

5. The system as claimed in claim 1, further comprising a client-end computer, which connects with the electronic coupon delivery server through Internet.

6. The system as claimed in claim 5, wherein the wireless communication device is a mobile phone, and the mobile phone and the client-end computer respectively have a bluetooth module to establish a wireless connection.

7. The system as claimed in claim 1, wherein the interactive service server further connects with a payment and transaction system to provide the buyer to undertake a payment and transaction.

8. The system as claimed in claim 1, wherein the buyer uses the wireless communication device to ask the electronic coupon delivery server to reserve a required electronic coupon, which is requested by the buyer and run out, such that the electronic coupon delivery server sends a short message to the buyer when the required electronic coupon is available.

9. The system as claimed in claim 1, wherein the electronic coupon delivery server is implemented in a public place.

10. The system as claimed in claim 1, wherein the wireless communication device records valid dates of the electronic coupons in order to remind the buyer before an valid date is immediately reached.

11. The system as claimed in claim 1, wherein the shop uses the interactive service server to edit the electronic coupons using the web browser connecting to the coupon delivery server.

12. The system as claimed in claim 11, wherein the interactive service server is a personal computer.

13. An electronic coupon transaction method, which allows a buyer to use electronic coupons to transact with a shop implementing with an interactive service server, the method comprising:
an electronic coupon editing step, in which the shop edits and stores the electronic coupons in an electronic coupon delivery server;
an electronic coupon receiving step, in which the buyer uses a wireless communication device to receive stored electronic coupons from the electronic coupon delivery server; and
a transacting step, in which the buyer connects the wireless communication device with the interactive service server in order to select one or more of the electronic coupons edited by the shop for transaction with the shop.

14. The method as claimed in claim 13, further comprising, before the transacting step, an identifying step, in which the buyer connects the wireless communication device with the interactive service server in order to obtain an identification of the shop to accordingly find and list the electronic coupons edited by the shop and received by the wireless communication device.

15. The method as claimed in claim 13, further comprising:
a conformation certificate obtaining step, in which the shop issues a conformation certificate to the buyer after the transaction is completed; and
a goods obtaining step, which provides the buyer to obtain goods transacted with the shop according to the conformation certificate.

16. The method as claimed in claim 13, further comprising:
a transaction recording step, in which the shop records transaction and basic information of the buyer; and
a record analyzing step, in which the shop analyzes consuming habits of the buyer based on the transaction and basic information and accordingly provides electronic coupons suitable to the buyer.

17. The method as claimed in claim 16, further comprising a record returning step, in which the shop sends the transaction information back to the wireless communication device used by the buyer.

18. The method as claimed in claim 13, wherein, in the electronic coupon receiving step, the buyer uses the wireless communication device to ask the electronic coupon delivery server to reserve a required electronic coupon, which is requested by the buyer and run out, such that the electronic coupon delivery server sends a short message to the buyer when the required electronic coupon is available.

19. The method as claimed in claim 13, wherein, in the electronic coupon editing step, the shop uses the interactive service server to edit the electronic coupons.

20. The method as claimed in claim 19, wherein the interactive service server is a personal computer.
